(19) United States
(12) Patent Application Publication
(10) Pub. No.: US 2026/0296015 A1
(43) Pub. Date: Oct. 1, 2026

(54) LIQUID DISCHARGE HEAD

(71) Applicant: CANON KABUSHIKI KAISHA, Tokyo (JP)

(72) Inventors: KOICHI ISHIDA, Tokyo (JP); KEIJI TOMIZAWA, Kanagawa (JP); SHUZO IWANAGA, Kanagawa (JP)

(21) Appl. No.: 19/574,954

(22) Filed: Mar. 23, 2026

(30) Foreign Application Priority Data
Mar. 25, 2025 (JP) 2025-050809

(51) Int. Cl. B41J 2/14; B41J 2/18

(52) U.S. Cl. CPC B41J 2/1433; B41J 2/14032; B41J 2/14145; B41J 2/18; B41J 2002/14419; B41J 2202/11; B41J 2202/12

(57) ABSTRACT

A liquid discharge head includes a discharge port configured to discharge a liquid, an individual flow path including a pressure chamber which communicates with the discharge port while facing the discharge port in a direction in which to discharge the liquid, a first flow path connected to the pressure chamber, and a second flow path connected to the pressure chamber on a side opposite to the first flow path, and a common flow path connected to a plurality of individual flow paths each corresponding to the individual flow path, wherein a flow resistance of the first flow path is smaller than a flow resistance of the second flow path, and wherein, as viewed from the direction in which to discharge the liquid, a flow resistance of the discharge port is larger on a side of the first flow path than on a side of the second flow path.

### BACKGROUND

### Field of the Technology

The present disclosure relates to a liquid discharge head.

### DESCRIPTION OF THE RELATED ART

A liquid discharge apparatus such as an inkjet printer is equipped with a liquid discharge head employing, for example, a thermal inkjet method which applies heat to a liquid to cause film boiling thereof and uses force of bubble release caused by the film boiling or a piezoelectric method which ejects a liquid with use of a change in shape of a piezoelectric element.

For achieving the high image quality of a recorded image using discharge of a liquid, increasing the density of discharge ports per discharge port array composed of a plurality of discharge ports arranged side by side is effective. Japanese Patent Laid-Open No. 2017-144699 describes a liquid discharge head in which adjoining discharge ports are staggered each other.

Depending on the array of discharge ports or the flow path configuration thereof, for example, in a case where discharge ports are arranged in a staggered manner as with the liquid discharge head described in Japanese Patent Laid-Open No. 2017-144699, the flow resistance of a liquid in a connection portion between a pressure chamber and a flow path adjacent to the pressure chamber may become asymmetrical. At this time, in the case of performing discharge with the thermal inkjet method, bubble release which is generated becomes asymmetrical, so that the discharge direction may incline and thus deviate from an ideal landing position and, therefore, image deterioration is a concern.

### SUMMARY

The present disclosure is directed to, in a liquid discharge head, arranging discharge ports at high density as well as preventing or reducing landing position deviation.

According to some embodiments of the present disclosure, a liquid discharge head includes a discharge port configured to discharge a liquid, an individual flow path including a pressure chamber which communicates with the discharge port while facing the discharge port in a direction in which to discharge the liquid, a first flow path connected to the pressure chamber, and a second flow path connected to the pressure chamber on a side opposite to the first flow path, and a common flow path connected to a plurality of individual flow paths each corresponding to the individual flow path, wherein a flow resistance of the first flow path is smaller than a flow resistance of the second flow path, and wherein, as viewed from the direction in which to discharge the liquid, a flow resistance of the discharge port is larger on a side of the first flow path than on a side of the second flow path.

According to another aspect of the present disclosure, a liquid discharge head includes a discharge port configured to discharge a liquid, an individual flow path including a pressure chamber which communicates with the discharge port while facing the discharge port in a direction in which to discharge the liquid, a first flow path connected to the pressure chamber, and a second flow path connected to the pressure chamber on a side opposite to the first flow path, and a common flow path connected to a plurality of individual flow paths each corresponding to the individual flow path, wherein a flow resistance of the first flow path is smaller than a flow resistance of the second flow path, and wherein, as viewed from the direction in which to discharge the liquid, the discharge port includes at least two protrusions which protrude toward a center of the discharge port and a length of one of the projections provided on a side closer to the first flow path than the center is larger than a length of another of the projections provided on a side closer to the second flow path than the center.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating a liquid discharge apparatus according to an embodiment of the present disclosure.

FIG. 2 is a conceptual diagram illustrating a control system according to the embodiment of the present disclosure.

FIG. 3 is a schematic diagram illustrating a circulation channel of a liquid according to the embodiment of the present disclosure.

FIG. 4A is a perspective view illustrating a liquid discharge head according to the embodiment of the present disclosure.

FIG. 4B is a perspective view illustrating the liquid discharge head according to the embodiment of the present disclosure.

FIG. 5 is an exploded perspective view of the liquid discharge head according to the embodiment of the present disclosure.

FIGS. 6A, 6B, 6C, and 6D are plan views of a flow path member according to the embodiment of the present disclosure.

FIG. 7A is a see-through diagram of the flow path member according to the embodiment of the present disclosure.

FIG. 7B is a sectional view of the flow path member according to the embodiment of the present disclosure.

FIG. 8A is a perspective view of a discharge module according to the embodiment of the present disclosure.

FIG. 8B is an exploded perspective view of the discharge module according to the embodiment of the present disclosure.

FIG. 9A is a plan view of an element substrate according to the embodiment of the present disclosure.

FIG. 9B is an enlarged view of the element substrate according to the embodiment of the present disclosure.

FIG. 9C is a plan view of the element substrate according to the embodiment of the present disclosure.

FIG. 10 is a sectional view of the element substrate according to the embodiment of the present disclosure.

FIG. 11A is a plan view illustrating the inside of a liquid discharge head according to a first embodiment of the present disclosure.

FIG. 11B is a sectional view illustrating the inside of the liquid discharge head according to the first embodiment of the present disclosure.

FIG. 12 is a plan view illustrating the inside of a liquid discharge head in a comparative example.

FIGS. 13A and 13B are schematic diagrams illustrating the manner of bubble release in the comparative example.

FIGS. 14A, 14B, 14C, 14D, 14E, and 14F are plan views illustrating examples of discharge port shapes according to the first embodiment of the present disclosure.

FIG. 15 is a plan view illustrating the inside of a liquid discharge head according to a second embodiment of the present disclosure.

FIG. 16 is a plan view illustrating the inside of a liquid discharge head according to a third embodiment of the present disclosure.

FIG. 17 is a plan view illustrating the inside of a liquid discharge head according to a fourth embodiment of the present disclosure.

### DESCRIPTION OF THE EMBODIMENTS

Various embodiments, features, and aspects of the present disclosure will be described in detail below with reference to the drawings. However, the following description should not be construed to limit the scope of the present disclosure. Furthermore, a liquid discharge head described in the present disclosure for discharging a liquid and a liquid discharge apparatus equipped with the liquid discharge head are applicable to various apparatuses such as a printer, a copying machine, a facsimile apparatus having a communication unit, and a word processor having a printer unit. Additionally, the liquid discharge head and the liquid discharge apparatus are also applicable to industrial equipment obtained by multiply combining the liquid discharge head or liquid discharge apparatus with various processing apparatuses. For example, the liquid discharge head or liquid discharge apparatus can be used for purposes of, for example, biochip production, electronic circuit printing, and semiconductor substrate fabrication.

While an embodiment of the present disclosure is a liquid discharge apparatus with a configuration of circulating a liquid such as ink between a tank and a liquid discharge head, the liquid discharge apparatus can have another configuration. For example, the liquid discharge apparatus can have a configuration of, without circulating a liquid, providing two tanks at the upstream side and downstream side of the liquid discharge head and causing ink to flow from one tank to the other tank, thus causing ink contained in a pressure chamber to move and flow. Moreover, the liquid discharge head can be a liquid discharge head which is not configured to circulate ink or cause ink contained in a pressure chamber to move and flow.

Moreover, while an embodiment of the present disclosure is what is called a line type (page wide type) head which has a length corresponding to the width of a recording medium, the present disclosure can also be applied to what is called a serial type liquid discharge head which performs recording while performing scanning on a recording medium. While an example of the serial type liquid discharge head has a configuration in which each liquid discharge head includes, for example, one recording element substrate for black ink and one recording element substrate for color ink, the present disclosure is not limited to this example. The liquid discharge head can have a configuration in which a short-length line head shorter than the width of a recording medium is produced in such a manner that several recording element substrates are arranged in such a way as to cause discharge ports to overlap each other in the discharge port array direction and the line head is caused to perform scanning on the recording medium.

In the following description, an example of the embodiment of the present disclosure is described with reference to the drawings.

### Description of Basic Configuration of Present Disclosure

### Overall Configuration of Liquid Discharge Apparatus

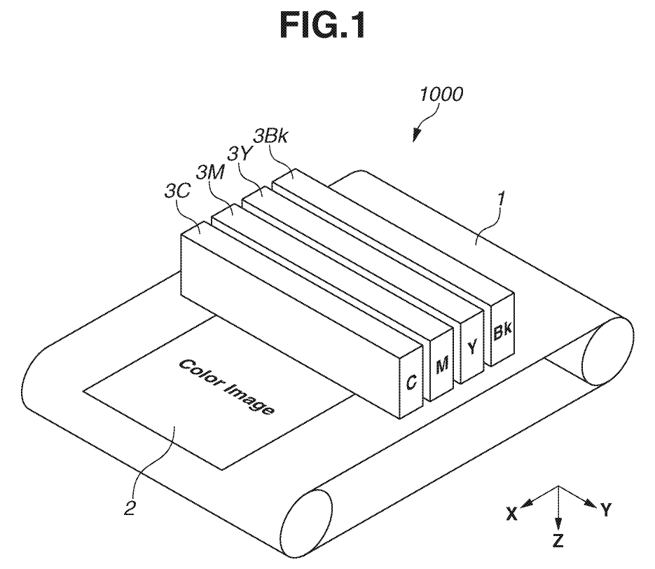

FIG. 1 is a diagram illustrating an example of a liquid discharge apparatus according to the present embodiment. The liquid discharge apparatus in the present embodiment is a liquid discharge apparatus 1000 (hereinafter, also referred to simply as "apparatus 1000") serving as an inkjet printer which records a color image on a recording medium 2 by discharging inks of yellow (Y), magenta (M), cyan (C), and black (Bk). In FIG. 1, the X-direction is a conveyance direction of the recording medium 2, the Y-direction is a width direction of the recording medium 2, and the Z-direction is a direction perpendicular to the X-direction and the Y-direction and is a direction in which a liquid is discharged.

FIG. 1 illustrates the apparatus 1000 having a configuration in which a liquid discharge head 3 directly applies ink to the recording medium 2, which is conveyed in the X-direction. The recording medium 2 is conveyed in the X-direction at a predetermined speed below four liquid discharge heads 3 (3C, 3M, 3Y, and 3Bk), which are mounted at a conveyance unit 1 and discharge respective different inks. Referring to FIG. 1, the four liquid discharge heads 3 are arranged in the X-direction in the order of 3Bk, 3Y, 3M, and 3C, and, to the recording medium 2, respective inks are applied in the order of black, yellow, magenta, and cyan. In each liquid discharge head 3, a plurality of discharge ports for ejecting ink is arrayed in the Y-direction.

Furthermore, while, in FIG. 1, a cut sheet is illustrated as the recording medium 2, the recording medium 2 can be continuous form paper, which is supplied from roll paper. Moreover, the recording medium 2 is not limited to paper, but can be, for example, a film.

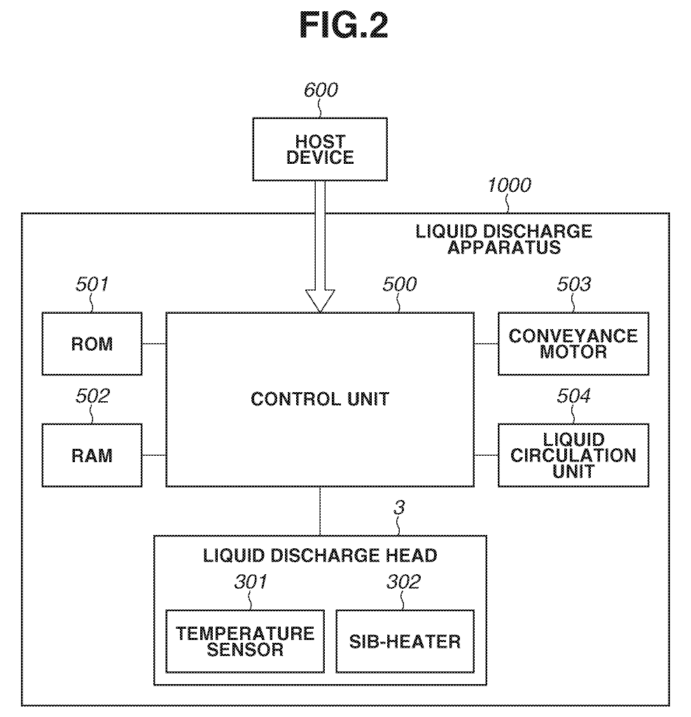

FIG. 2 is a block diagram used to explain a configuration for control in the liquid discharge apparatus 1000. A control unit 500 is composed of, for example, a central processing unit (CPU) and controls the entire liquid discharge apparatus 1000 while using a random access memory (RAM) 502 as a work area according to programs and various parameters stored in a read-only memory (ROM) 501. The control unit 500 performs predetermined image processing on image data received from an externally connected host device 600 according to programs and various parameters stored in the ROM 501, and thus generates discharge data for enabling the liquid discharge head 3 to perform discharge. Then, the control unit 500 drives the liquid discharge head 3 according to the discharge data to cause the liquid discharge head 3 to discharge ink at a predetermined frequency.

During the liquid discharge head 3 performing a discharge action, the control unit 500 drives a conveyance motor 503 to convey the recording medium 2 in the X-direction at a speed corresponding to the drive frequency. With this driving, an image corresponding to image data received from the host device 600 is then recorded on the recording medium 2. In the ROM 501, information about a use area of each discharge port which is to be used for discharge in the liquid discharge head 3 is preliminarily stored in a rewritable manner for each liquid discharge head 3.

### Circulation Channel of Liquid

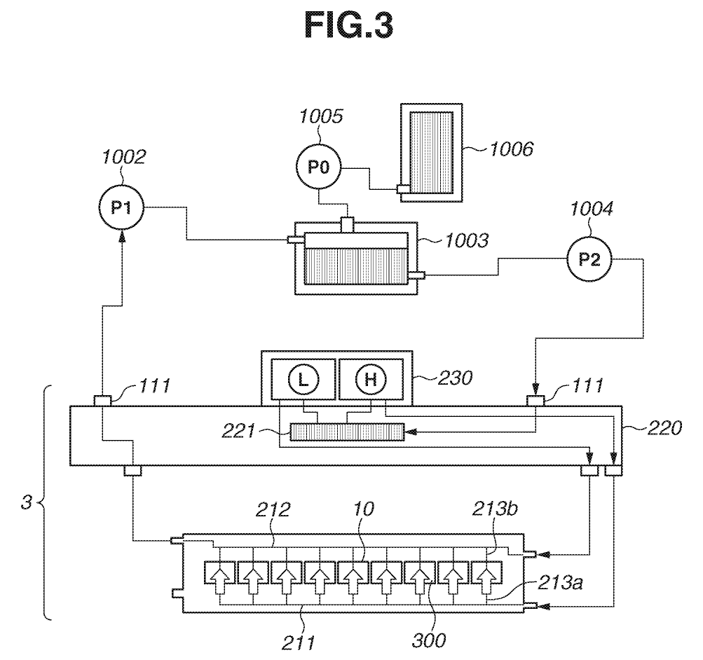

FIG. 3 is a schematic diagram illustrating a circulation channel of a liquid in the liquid discharge apparatus in the present embodiment and illustrates a configuration in which the liquid discharge head 3 is fluidically connected to, for example, a first circulation pump 1002 and a buffer tank 1003. Furthermore, while, in FIG. 3, only a channel in which ink for the liquid discharge head associated with one color ink moves and flows is illustrated, the main body of the liquid discharge apparatus 1000 is provided with respective circulation channels associated with types of liquids, such as inks, to be discharged.

The buffer tank 1003, which is connected to a main tank 1006 and serves as a sub-tank, includes an atmospheric communication port (not illustrated) which is used to allow the inside and outside of the buffer tank 1003 to communicate with each other, thus enabling bubbles in ink to be exhausted to the outside. The buffer tank 1003 is also connected to a refill pump 1005. When the liquid has been consumed at the liquid discharge head 3 due to ink being discharged (exhausted) from discharge ports of the liquid discharge head 3, such as recording or suction recovery using discharge of ink, the refill pump 1005 transfer an amount of ink corresponding to the consumed ink from the main tank 1006 to the buffer tank 1003.

The first circulation pump 1002 has the role of drawing out the liquid from a liquid connection portion 111 of the liquid discharge head 3 and causes the drawn-out liquid to flow to the buffer tank 1003. At the time of the liquid discharge head 3 being driven, a given amount of ink is caused by the first circulation pump 1002 to flow inside a shared collection flow path 212.

A negative-pressure control unit 230 is provided in a channel between a second circulation pump 1004 and a liquid discharge unit 300. The negative-pressure control unit 230 has the function of operating in such a way as to keep a pressure on the more downstream side than the negative-pressure control unit 230 (on the side close to the liquid discharge unit 300) to a preliminarily set constant pressure even in a case where the flow rate in the circulation system has varied due to a difference in duty for performing recording.

As illustrated in FIG. 3, the negative-pressure control unit 230 includes two pressure adjustment mechanisms, and respective different control pressures are set for the respective pressure adjustment mechanisms. The two pressure adjustment mechanisms include a negative-pressure control portion 230H (in FIG. 3, denoted by H), which is set to a relatively high pressure, and a negative-pressure control portion 230L (in FIG. 3, denoted by L), which is set to a relatively low pressure. Each of the negative-pressure control portion 230H and the negative-pressure control portion 230L is connected via a liquid supply unit 220 to a shared supply flow path 211 and the shared collection flow path 212, which are contained in the liquid discharge unit 300. The liquid discharge unit 300 is provided with an individual supply flow path 213a and an individual collection flow path 213b, each of which communicates with the shared supply flow path 211, the shared collection flow path 212, and the respective element substrates 10 having discharge ports. The details of each element substrate 10 are described below. Since the individual flow paths 213 communicate with the shared supply flow path 211 and the shared collection flow path 212, part of the liquid which is caused to flow by the second circulation pump 1004 passes through an internal flow path of the element substrate 10 from the shared supply flow path 211 and then flows to the shared collection flow path 212 (outline arrows in FIG. 3). This is because a pressure difference is provided between the pressure adjustment mechanism H connected to the shared supply flow path 211 and the pressure adjustment mechanism L connected to the shared collection flow path 212 and the first circulation pump 1002 is connected only to the shared collection flow path 212.

In this way, in the liquid discharge unit 300, there occur a flow of the liquid passing through the inside of the shared collection flow path 212 and a flow of the liquid passing through the inside of each element substrate 10 from the shared supply flow path 211 and then flowing to the shared collection flow path 212. Therefore, it is possible to exhaust heat generated in each element substrate 10 to the outside of the element substrate 10 with use of the flow of the liquid from the shared supply flow path 211 to the shared collection flow path 212. Moreover, with such a configuration, it is possible to, when recording with the liquid discharge head 3 is being performed, cause the flow of ink to occur even in discharge ports or pressure chambers in which recording is not being performed, so that it is possible to prevent or reduce an increase in viscosity of ink in those regions. Moreover, it is possible to exhaust ink increased in viscosity or foreign material contained in ink to the shared collection flow path 212. Therefore, the liquid discharge head 3 in the present embodiment becomes able to perform high-speed and high-image quality recording.

### Configuration of Liquid Discharge Head

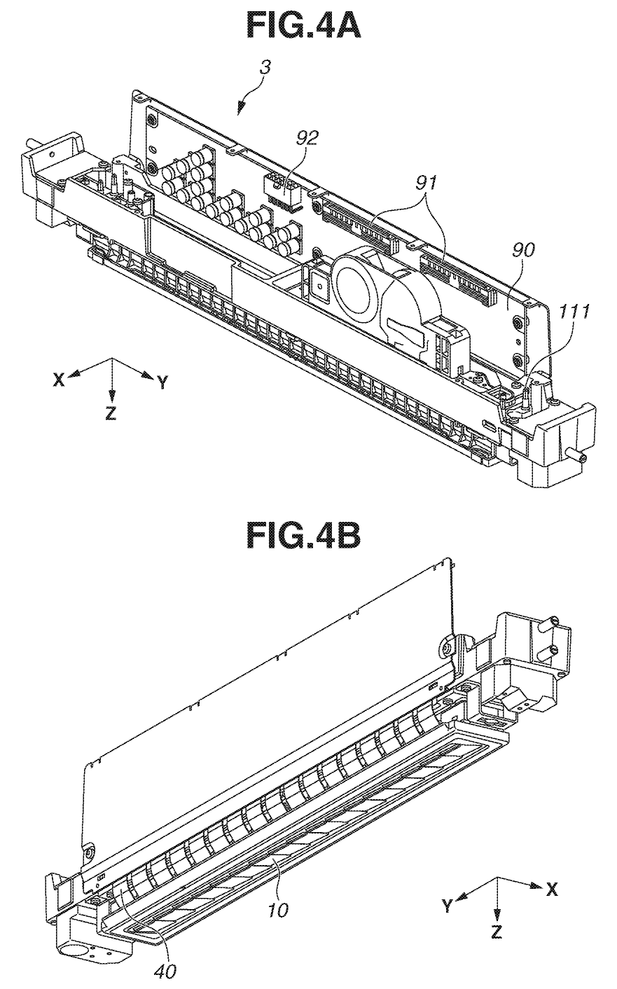

FIGS. 4A and 4B are perspective views of the liquid discharge head 3 according to the present embodiment. The liquid discharge head 3 is a line type liquid discharge head in which 17 element substrates 10 capable of discharging ink are linearly arrayed (arranged in line). As illustrated in FIGS. 4A and 4B, the liquid discharge head 3 includes the respective element substrates 10 and signal input terminals 91 and electric power supply terminals 92, which are electrically connected to the element substrates 10 via an electrical wiring board (flexible wiring board) 40 and an electrical wiring board 90. The signal input terminals 91 and the electric power supply terminals 92 are electrically connected to the control unit 500 of the apparatus 1000 and supply a discharge drive signal and electric power used for discharge, respectively, to the element substrates 10. Aggregating wirings with use of electrical circuits contained in the electrical wiring board 90 enables reducing the numbers of signal input terminals 91 and electric power supply terminals 92 as compared with the number of element substrates 10. With this configuration, the number of electrical connection portions for mounting the liquid discharge head 3 to the apparatus 1000 or the number of electrical connection portions to be detached at the time of replacement of the liquid discharge head 3 may be small. As illustrated in FIG. 4A, the liquid connection portion 111, which is provided at one side of the liquid discharge head 3, is connected to a liquid supply system of the apparatus 1000.

With this configuration, ink is supplied from the supply system of the apparatus 1000 to the liquid discharge head 3, and ink which has passed through the inside of the liquid discharge head 3 is collected to the supply system of the apparatus 1000. In this way, ink is able to be circulated via the channel of the apparatus 1000 and the channel of the liquid discharge head 3.

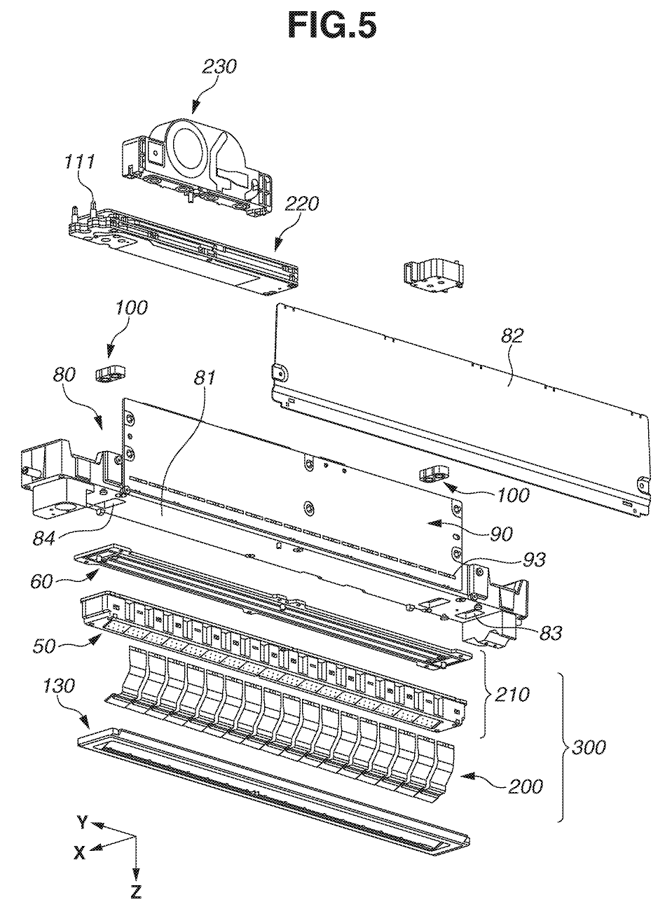

FIG. 5 is an exploded perspective view illustrating respective components and units constituting the liquid discharge head 3. The liquid discharge unit 300, the liquid supply unit 220, and the electrical wiring board 90 are attached to a chassis 80. The liquid supply unit 220 is provided with the liquid connection portion 111, and the inside of the liquid supply unit 220 is provided with a filter 221 (FIG. 3), which communicates with respective openings of the liquid connection portion 111 to remove foreign matter contained in ink to be supplied. The liquid having passed through the filter 221 is supplied to the negative-pressure control unit 230 arranged on the liquid supply unit 220. The negative-pressure control unit 230 is a unit including a pressure adjustment valve, and, by actions of, for example, valves and sprint members provided in the respective negative-pressure control portions, considerably attenuates a pressure drop change inside the supply system (a supply system on the upstream side of the liquid discharge head 3) of the apparatus 1000 caused by a variation in flow rate of the liquid.

With this configuration, it is possible to stabilize a negative pressure change on the more downstream side (on the side close to the liquid discharge unit 300) than the negative-pressure control unit 230. Two negative-pressure control portions 230L and 230H each including a pressure adjustment valve are incorporated in the negative-pressure control unit 230. The negative-pressure control portions 230L and 230H are preliminarily set to respective different control pressures. The high-pressure side negative-pressure control portion 230H communicates with the shared supply flow path 211 contained in the liquid discharge unit 300 via the liquid supply unit 220. The low-pressure side negative-pressure control portion 230L communicates with the shared collection flow path 212 via the liquid supply unit 220. The chassis 80 includes a liquid discharge unit supporting portion 81 and an electrical wiring board supporting portion 82 to support the liquid discharge unit 300 and the electrical wiring board 90 and also ensure the rigidity of the liquid discharge head 3. The electrical wiring board supporting portion 82 is a portion configured to support the electrical wiring board 90 and is fixed to the liquid discharge unit supporting portion 81 by screws. The liquid discharge unit supporting portion 81 is provided with openings 83 and 84, into which joint rubbers 100 are inserted. The liquid, which is supplied from the liquid supply unit 220, is guided to a second flow path member 60, which constitutes the liquid discharge unit 300, via the joint rubbers 100.

Next, a configuration of a flow path member 210 included in the liquid discharge unit 300 is described. As illustrated in FIG. 5, in the flow path member 210, a first flow path member 50 and the second flow path member 60 are stacked each other. To a bonding surface of the first flow path member 50, a plurality of discharge modules 200 is bonded with adhesive (not illustrated). The flow path member 210 is a flow path member configured to distribute a liquid supplied from the liquid supply unit 220 to the respective discharge modules 200 and return a liquid flowing out from the respective discharge modules 200 to the liquid supply unit 220. Moreover, the flow path member 210 is fixed to the liquid discharge unit supporting portion 81 by screws, so that warpage or deformation of the flow path member 210 is prevented or reduced.

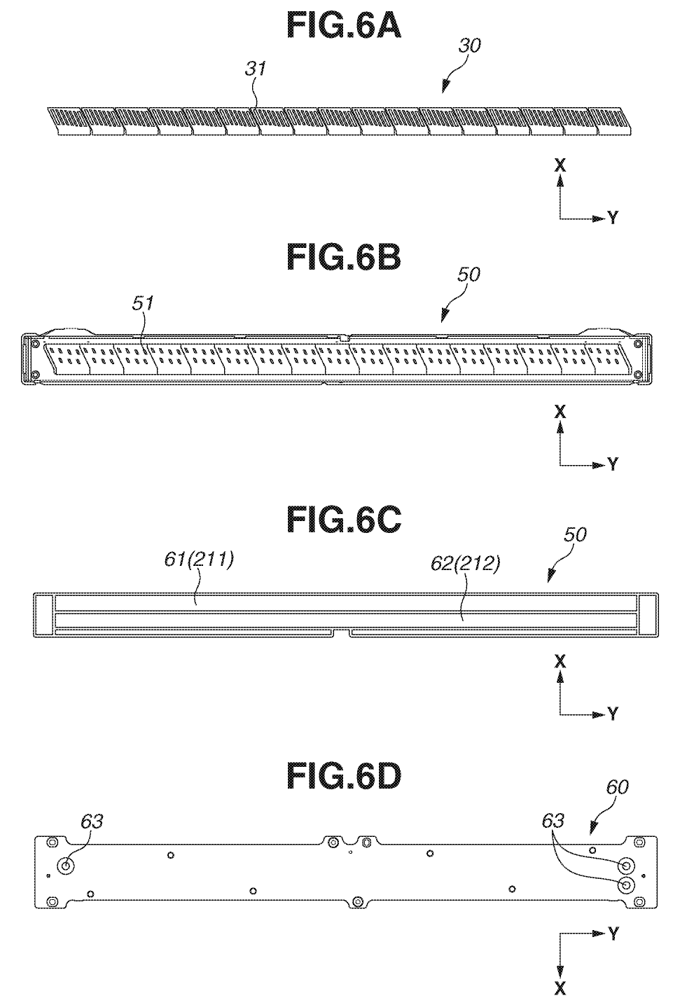

FIGS. 6A to 6D are diagrams used to explain the detailed configuration of the flow path member 210. FIG. 6A illustrates supporting members 30, which are provided on the surface on the side on which the discharge modules 200 of the first flow path member 50 are mounted, and FIG. 6B illustrates an abutting-contact surface of the first flow path member 50 with respect to the supporting members 30. FIG. 6C is a sectional view in a surface which is perpendicular to the Z-direction of the first flow path member 50 and is in the vicinity of the middle thereof in the Z-direction, and FIG. 6D illustrates a surface of the second flow path member 60 on the side which is in abutting contact with the liquid discharge unit supporting portion 81. Furthermore, FIGS. 6A to 6C are drawings as viewed from the side of the discharge modules 200, and FIG. 6D is a diagram as viewed from the side of the liquid discharge unit supporting portion 81.

On a surface of the first flow path member 50 opposite to the second flow path member 60, a plurality of supporting members 30 arrayed in the Y-direction is arranged, and one element substrate 10 is arranged for each supporting member 30. Adjusting the number of arrayed discharge modules 200 enables configuring liquid discharge heads 3 of various sizes.

As illustrated in FIG. 6A, the supporting members 30 are fluidically connected to the element substrates 10 at the surface where the supporting members 30 are in abutting contact with the element substrates 10, and include communication openings 31 serving as the individual supply flow path 213a and the individual collection flow path 213b described above with reference to FIG. 3. As illustrated in FIG. 6B, the communication openings 31 fluidically communicate with the shared supply flow path 211 or the shared collection flow path 212 via communication openings 51 included in the flow path member 50.

As illustrated in FIG. 6C, in a middle layer present in the vicinity of the middle in the Z-direction of the first flow path member 50, common flow paths 61 and 62, which serve as the shared supply flow path 211 and the shared collection flow path 212 described above with reference to FIG. 3, respectively, extend in the Y-direction. As illustrated in FIG. 6D, at both ends or one end of each of the common flow paths 61 and 62, shared communication openings 63, which fluidically communicate with the liquid supply unit 220, are formed.

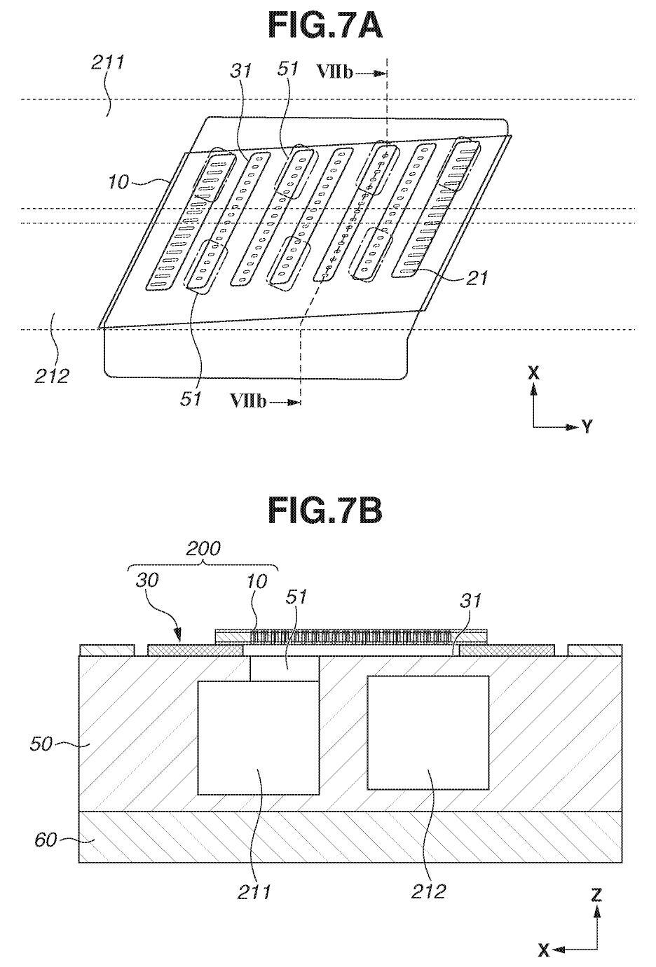

FIGS. 7A and 7B are a see-through diagram and a sectional view, respectively, used to explain a flow path structure formed inside the liquid discharge unit 300. FIG. 7A is an enlarged see-through diagram of the flow path member 210 as viewed from the Z-direction, and FIG. 7B is a sectional view taken along line VIIb - VIIb in FIG. 7A.

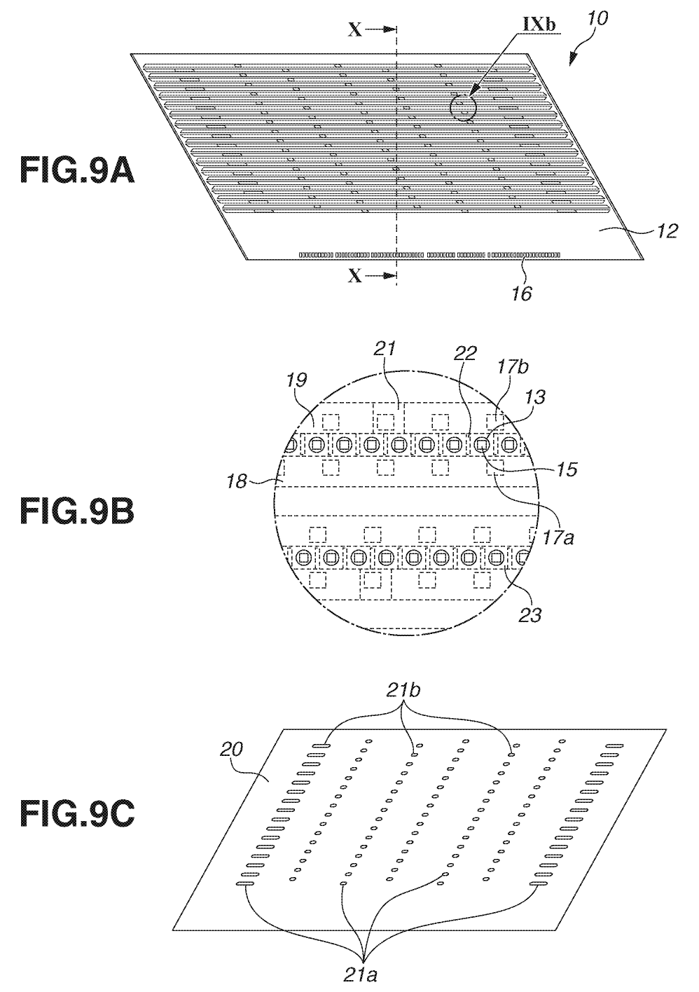

The element substrates 10 of the discharge modules 200 are placed on the communication openings 51 of the first flow path member 50 via the supporting members 30. Furthermore, while, in FIG. 7B, only the communication opening 51 corresponding to the shared supply flow path 211 is illustrated, in another cross-section, the shared collection flow path 212 and the communication openings 51 communicate with each other as illustrated in FIGS. 6A to 6D. In the supporting members 30 and the element substrates 10 included in each discharge module 200, a flow path for supplying ink supplied from the first flow path member 50 to a heating resistance element 15 (see FIG. 9B) provided in each element substrate 10 is formed. Additionally, in the supporting members 30 and the element substrates 10, a flow path for collecting (returning) a part or the whole of a liquid supplied to the heating resistance element 15 to the first flow path member 50 is formed.

As mentioned above, the shared supply flow path 211 is connected to the relatively high-pressure negative-pressure control portion 230H, and the shared collection flow path 212 is connected to the relatively low-pressure negative-pressure control portion 230L. An ink supply channel for supplying ink to a flow path formed in each element substrate 10 through shared communication openings 63 (see FIG. 6D), the shared supply flow path 211, and the communication openings 31 is formed. Similarly, an ink collection channel including the communication openings 31, the communication openings 51, the shared collection flow path 212, and the shared communication openings 63 (see FIG. 6D) from the flow path formed in each element substrate 10 is formed. During the time when ink is circulated in the above-mentioned way, a discharge action corresponding to discharge data is performed in each element substrate 10, and ink which has not been consumed by the discharge action out of ink supplied in the ink supply channel is collected by the ink collection channel.

### Configuration of Discharge Module

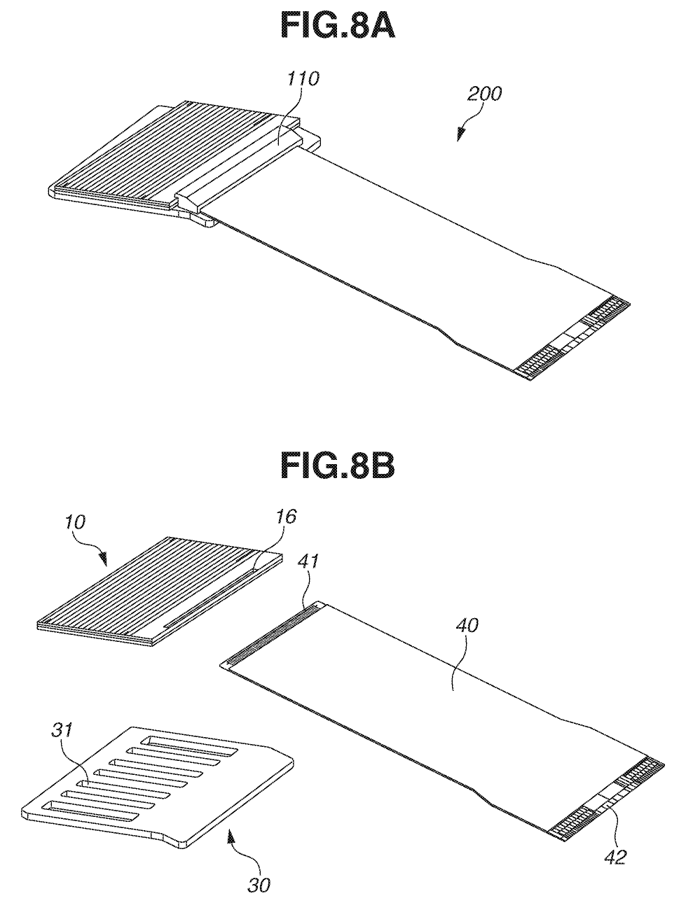

FIG. 8A is a perspective view illustrating one discharge module 200, and FIG. 8B is an exploded view thereof. The method of manufacturing the discharge module 200, first, bonds the element substrate 10 and the flexible wiring board 40 to the supporting member 30 with the communication openings 31 preliminarily provided therein. After that, the method electrically interconnects an electrode pad 16 of the element substrate 10 and terminals 41 on the flexible wiring board 40 by wire bonding, and then covers and seals a wire bonding portion (electrical connection portion) with a sealing member 110. With regard to examples of the flexible wiring board 40, a copper foil is bonded to a polyimide tape by adhesive, patterning is performed to form wirings on the copper foil, and the wirings are electrically connected to the electrode pad 16 of the element substrate 10. Terminals 42 of the flexible wiring board 40 on a side opposite to the element substrates 10 are electrically connected to connection terminals 93 (see FIG. 5) of the electrical wiring board 90. The supporting member 30 is not only a support medium which supports the element substrate 10 but also a flow path member which causes the element substrate 10 and the flow path member 210 to fluidically communicate with each other and, therefore, it is desirable for the supporting member 30 to be high in flatness and be able to be joined with the element substrate 10 with sufficiently high reliability. It is desirable that the material of the supporting member 30 be, for example, alumina or resin material.

### Configuration of Element Substrate

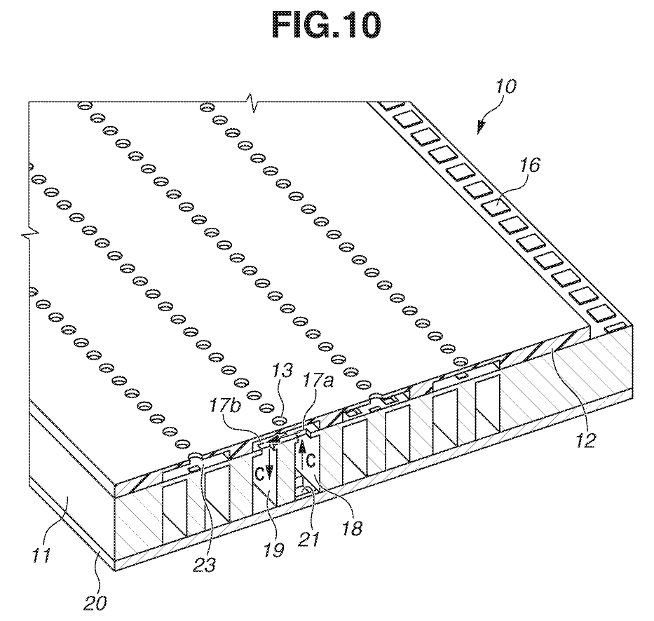

A configuration of the element substrate 10 in the present embodiment is described. FIG. 9A illustrates a plan view of a surface of the element substrate 10 on which discharge ports 13 are formed, FIG. 9B illustrates an enlarged view of a portion indicated by "IXb" illustrated in FIG. 9A, and FIG. 9C illustrates a plan view of the back surface of the element substrate 10, which is opposite to the surface illustrated in FIG. 9A. Moreover, FIG. 10 is a sectional perspective view of the element substrate 10 taken along line X - X in FIG. 9A. In the following description, the direction in which a discharge port array, in which a plurality of discharge ports 13 is arrayed, extends is referred to as the "discharge port array direction".

As illustrated in FIG. 9B, at the position corresponding to each discharge port 13, the heating resistance element 15, which is a heating element (pressure generation element) configured to cause a liquid to produce bubbles with use of thermal energy which the heating element generates, is arranged. A pressure chamber 23 which contains the heating resistance element 15 therein is formed as a compartment by a partition wall 22 formed in a first layer 121 (described below) of a flow path forming member 12. The heating resistance element 15 is electrically connected to the electrode pad 16 by an electrical wiring (not illustrated) provided in the element substrate 10. Then, the heating resistance element 15 generates heat based on a pulse signal input from the control unit 500 of the liquid discharge apparatus 1000 via the electrical wiring board 90 (see FIG. 5) and the flexible wiring board 40 (FIG. 8B), and thus boiling the liquid. The liquid is discharged from the discharge port 13 by the force of bubbles caused by such boiling. As illustrated in FIG. 9B, along each discharge port array, a liquid supply path 18 extends on one side of the discharge port array and a liquid collection path 19 extends on the other side of the discharge port array. The liquid supply path 18 and the liquid collection path 19 are flow paths extending in the discharge port array direction provided in the element substrate 10, and communicate with the discharge ports 13 via supply ports 17a (first supply ports) and collection ports 17b (second supply ports), respectively. Thus, both the supply ports 17a and the collection ports 17b are communication ports which are open on the surface of a substrate 11 on the side of the flow path forming member 12. FIGS. 9A to 9C illustrate, as an example, an element substrate 10 which includes 16 discharge port arrays.

As illustrated in FIG. 9C and FIG. 10, a sheet-like cover plate 20 is stacked on a reverse surface of the element substrate 10 which is opposite to the surface thereof on which discharge ports 13 are formed. As illustrated in FIG. 9C, the cover plate 20 is provided with a plurality of openings 21 which communicates with liquid supply paths 18 and liquid collection paths 19 described below. While, in the present embodiment, in the cover plate 20, four supply openings 21a are provided for each liquid supply paths 18 and three collection openings 21b are provided for each liquid collection path 19, the numbers of openings are not limited to such numbers. As illustrated in FIG. 9B, each opening 21 in the cover plate 20 communicates with the communication opening 51 illustrated in FIG. 7A. It is favorable that the cover plate 20 is a material with sufficient corrosion resistance against liquids, and high precision is useful for the opening shape and opening position of the opening 21 to enable ink to be supplied to the pressure chamber 23. Therefore, it is favorable that a photopolymer material or silicon plate is used as the material of the cover plate 20 and the openings 21 are provided by a photolithography technique. In this way, the cover plate 20 is a plate for converting the pitch of a low path with use of the openings 21, and it is desirable that, from the viewpoints of pressure loss, rigidity, and workability, the cover plate 20 is configured with a film-shaped member with a thickness of about 30 micrometers (μm) to 600 μm.

Next, the flow of a liquid in the element substrate 10 is described. In the element substrate 10, the substrate 11, which is formed from silicon, and the flow path forming member (discharge port forming member) 12, which is formed from photosensitive resin, are stacked on each other. The method of manufacturing the discharge port forming member 12 can be an optional manufacturing method such as a method of stacking a plurality of layers such as a first layer and a second layer on each other or a method of forming pressure chambers and discharge ports with use of, for example, a mold material. To the back surface of the substrate 11, the cover plate 20 is bonded. The cover plate 20 functions as a lid which forms parts of the walls of the liquid supply paths 18 and the liquid collection paths 19 formed in the substrate 11 of the element substrate 10. In the element substrate 10, on the side of one surface of the substrate 11, the heating resistance elements 15 are formed (see FIG. 9B), and, on the side of the back surface of the substrate 11, grooves constituting the liquid supply paths 18 and the liquid collection paths 19, which extend along the discharge port arrays, are formed. The liquid supply paths 18 and the liquid collection paths 19, which are formed from the substrate 11 and the cover plate 20, are connected to the shared supply flow path 211 and the shared collection flow path 212, respectively, in the flow path member 210 (see FIGS. 7A and 7B), so that a differential pressure is occurring between the liquid supply path 18 and the liquid collection path 19. This differential pressure causes the formation of a circulating flow C in which the liquid in the liquid supply path 18 provided in the substrate 11 flows to the liquid collection path 19 via the supply port 17a, the pressure chamber 23, and the collection port 17b (the flow indicated by arrow C in FIG. 10). With this flow, in the discharge ports 13 and the pressure chambers 23 which are not performing a discharge action, it is possible to collect, for example, thickened ink which is caused by evaporation from the discharge ports 13, bubbles, and foreign matter to the liquid collection path 19. Moreover, it is possible to prevent or reduce ink in the discharge port 13 or the pressure chamber 23 from being thickened or the density of a color material from increasing. As illustrated in FIGS. 7A and 7B, the liquid collected to the liquid collection path 19 is collected to the communication opening 31 of the supporting member 30, the communication opening 51 of the first flow path member 50, and the shared collection flow path 212 in this order via the openings 21 of the cover plate 20 and the communication openings 31 of the supporting member 30. After that, the liquid is collected to the supply channel of the liquid discharge apparatus 1000.

Thus, the liquid which is supplied from the main body of the liquid discharge apparatus 1000 to the liquid discharge head 3 moves and flows and is supplied and collected in the following order. The liquid, first, flows into the inside of the liquid discharge head 3 from the liquid connection portion 111 of the liquid supply unit 220. Then, the liquid is supplied to the joint rubbers 100, the shared communication openings 63 provided in the second flow path member 60, and the common flow path 61 and the communication openings 51 provided in the first flow path member 50, in this order. After that, the liquid is supplied to the pressure chamber 23 via the communication opening 31 provided in the supporting member 30, the opening 21 provided in the cover plate 20, and the liquid supply path 18 and the supply port 17a provided in the substrate 11 in this order. A liquid which is included in the liquid supplied to the pressure chamber 23 but is not discharged from the discharge ports 13 flows through the collection port 17b and the liquid collection path 19 provided in the substrate 11, the opening 21 provided in the cover plate 20, and the communication opening 31 provided in the supporting member 30 in this order. After that, the liquid flows through the communication opening 51 and the common flow path 62 provided in the first flow path member 50, the shared communication opening 63 provided in the second flow path member 60, and the joint rubber 100 in this order. Then, the liquid moves and flows from the liquid connection portion 111 provided in the liquid supply unit 220 to the outside of the liquid discharge head 3. In the configuration of the circulation channel illustrated in FIG. 3, the liquid which has flown in from the liquid connection portion 111 passes through the negative-pressure control unit 230 and is then supplied to the joint rubbers 100.

### First Embodiment

A first embodiment of the present disclosure is described. Functions and constituent elements similar to those in the basic configuration described above in the present disclosure are omitted from description here, and only differences therefrom are described.

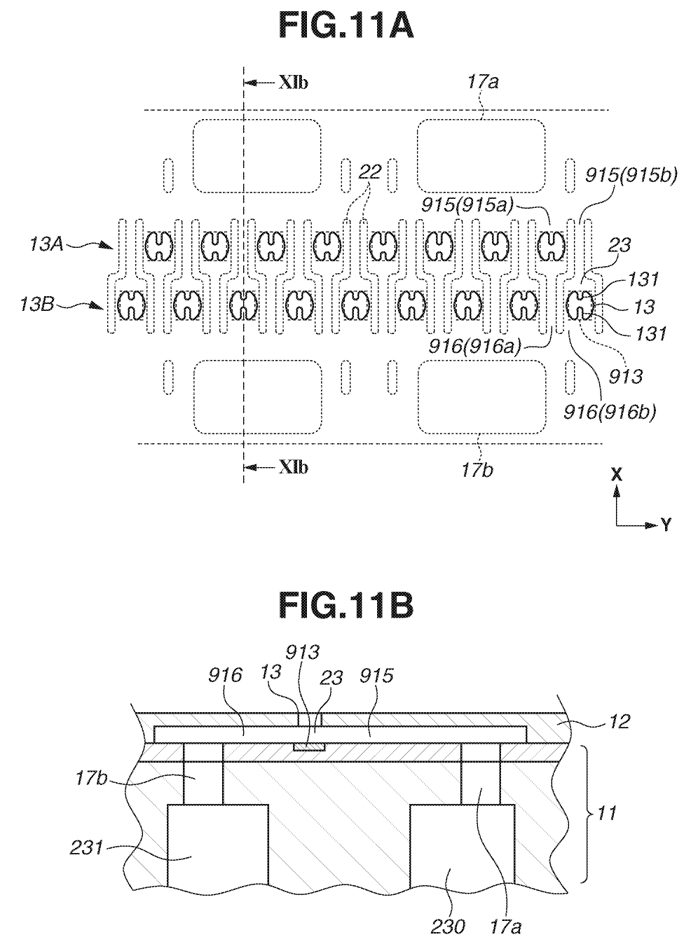

FIGS. 11A and 11B illustrate the inside of a liquid discharge head in the first embodiment. FIG. 11A is a plan view (see-through diagram) illustrating discharge ports 13, pressure generation elements 913, and flow paths. FIG. 11B is a sectional view taken along line XIb - XIb in FIG. 11A. Between the substrate 11 of the element substrate 10 and the flow path forming member 12, a plurality of pressure chambers 23 corresponding to the respective discharge ports 13 and an inflow path 915 and an outflow path 916 communicating with the respective pressure chambers 23 are provided. The pressure chamber 23 is partitioned with the partition walls 22 of the flow path forming member 12. The substrate 11 is configured in such a manner that a circulating flow C (see FIG. 10) in which the liquid in the liquid supply path 18 flows to the liquid collection path 19 via the supply port 17a, the inflow path 915, the pressure chamber 23, the outflow path 916, and the collection port 17b is formed. It is favorable that the speed of the circulating flow C in the pressure chamber 23 is, for example, greater than or equal to 1.0 millimeters per second (mm/s) and less than or equal to 250 mm/s, which is a speed that does not have an influence on, for example, the landing accuracy even if a discharge action is performed in a state in which the liquid is moving and flowing. Furthermore, as illustrated in FIG. 11B, the discharge port 13 is an opening portion formed in the flow path forming member 12 and located at the end portion of a tubular nozzle. The direction in which the liquid is discharged from the discharge port 13 (the vertical direction in FIG. 11B) is referred to as a "discharge direction".

In the substrate 11, a supply port array in which a plurality of supply ports (first openings) 17a, which are supply ports penetrating through the substrate 11, is arrayed and a collection port array in which a plurality of collection ports (second openings) 17b, which are collection ports penetrating through the substrate 11, is arrayed are formed. Between the supply port array and the collection port array, a discharge port array 13A and a discharge port array 13B, in each of which a plurality of discharge ports 13 are arrayed, are formed. Each discharge port 13 communicates with the pressure chamber 23, and the pressure generation element 913 is provided in the pressure chamber 23.

An individual flow path is formed which includes the pressure chamber 23 facing and communicating with the discharge port 13, the inflow path (first flow path) 915 connected to the pressure chamber 23, and the outflow path (second flow path) 916 connected to the pressure chamber 23 on the side opposite to the inflow path 915. Moreover, a common flow path (first common flow path) 230 connected to a plurality of individual flow paths and connected to the supply ports 17a and a common flow path (second common flow path) 231 connected to a plurality of individual flow paths and connected to the collection ports 17b are arranged in such a way as to extend in the extending directions of the discharge port array 13A and the discharge port array 13B, respectively. In the first embodiment illustrated in FIGS. 11A and 11B, in a channel leading from the supply port 17a and the collection port 17b to the individual flow path, a structure or stop such as a pillar or filter is not provided. This is for the purpose of causing the liquid to be resupplied to the pressure chamber as soon as possible after liquid discharge and implementing the higher productivity caused by an increase in discharge frequency.

An inflow path 915a communicating with the discharge port array 13A located at a position close to the supply port array is larger in cross-sectional area than an inflow path 915b communicating with the discharge port array 13B located at a position far from the supply port array. Moreover, an outflow path 916a communicating with the discharge port array 13A located at a position close to the supply port array is smaller in flow path cross-sectional area than an outflow path 916b communicating with the discharge port array 13B located at a position far from the supply port array. Therefore, the respective flow resistances of the inflow path 915 and the outflow path 916 which communicate with one pressure chamber 23 are asymmetric. Specifically, in a pressure chamber 23A corresponding to the discharge port array 13A, the flow resistance of a flow path leading from the center of the pressure generation element 913 to the supply port 17a through the inflow path 915 is smaller than the flow resistance of a flow path leading from the center of the pressure generation element 913 to the collection port 17b through the outflow path 916. Similarly, in a pressure chamber 23B corresponding to the discharge port array 13B, the flow resistance of a flow path leading from the center of the pressure generation element 913 to the collection port 17b through the outflow path 916 is smaller than the flow resistance of a flow path leading from the center of the pressure generation element 913 to the supply port 17a through the inflow path 915.

The discharge amount of the discharge liquid droplet is, for example, about 4 nanograms (ng), and, in this case, the size of each discharge port is accordingly about 20 μm in width. Moreover, it is favorable that, from the viewpoints of the reliability in usage or the accuracy in manufacturing, the partition wall 22 for separating the pressure chambers from each other has a wall thickness of at least about 4 μm. Therefore, even if discharge ports are tried to be arranged at high density, the interval between discharge ports which allows aligning discharge ports in the same straight line is limited, so that it is difficult to perform high-density arrangement of discharge ports at 800 dots per inch (dpi) (32 μm) or more. Due to the limitations of this geometrical arrangement, in the configuration illustrated in FIG. 11A, each of the discharge port array 13A and the discharge port array 13B is arrayed at 600 dpi. In this way, in the surface of the substrate 11, the discharge port arrays are shifted from each other in a direction perpendicular to the array direction of discharge ports, so that individual flow paths which are asymmetric in planar shape are arranged alternately one by one. In other words, a plurality of discharge ports 13 is arranged side by side in a second direction (Y-direction) intersecting with a first direction (X-direction), and two discharge port arrays 13A and 13B are formed in which discharge ports 13 adjacent in the second direction are arranged while being shifted from each other in the first direction. Accordingly, with a combination of such two discharge port arrays, the discharge port density with a high density of 1,200 dpi is implemented. To attain a high image quality of a recorded image by discharge of a liquid, it is desirable that the discharge port density obtained with a combination of two discharge port arrays 13A and 13B be greater than or equal to 800 dpi. Moreover, to implement a high discharge port density, it is desirable that the discharge port density be greater than or equal to 600 dpi in one discharge port array.

In the liquid discharge head in the first embodiment illustrated in FIG. 11A, to enable forming discharge liquid droplets in a more favorable manner, each discharge port 13 includes projection portions 131. More specifically, one discharge port 13 includes two projection portions 131 projecting toward the center of the discharge port in planar view, and the projection portions 131 extend (are projecting) in directions approximately perpendicular to the discharge port array direction. Furthermore, in FIG. 11B, the projection portions 131 are omitted from illustration. The discharge liquid droplet tends to incline in the projecting direction of the projection portion 131 at the time of flying.

If landing of the discharge liquid droplet deviates in the discharge port array direction, the quality of a formed image on, for example, a recording medium tends to be deteriorated. Accordingly, if one discharge port 13 includes three or more projection portions 131, some of the projection portions 131 may face in the discharge port array direction. Therefore, it is desirable that one discharge port 13 include two or less projection portions 131, which project in directions parallel to the conveyance direction of a recording medium. However, even in a case where the discharge port 13 include three or more projection portions 131, an advantageous effect of the present disclosure can be obtained.

Due to the discharge port including at least one projection portion, the rear end portion of a discharge liquid droplet which has moved toward the center of the pressure generation element at the time of discharge is narrowed down, so that the tail thereof becomes thin. As a result, since the tail length becomes short, it is possible to prevent or reduce a phenomenon in which a liquid droplet separates from a main droplet so that a satellite droplet occurs. Even if a satellite droplet having separated from a main droplet occurs, since the tail length is short, an advantageous effect in which the satellite droplet is small and the number of satellite droplets becomes small can be obtained.

In the liquid discharge head in the first embodiment illustrated in FIGS. 11A and 11B, out of the projection portions 131, a projection portion 131 of each discharge port belonging to the discharge port array 13A located at a position close to the supply port array is formed longer than a projection portion 131 of the discharge port far from the supply port array. Moreover, a projection portion 131 of each discharge port belonging to the discharge port array 13B located at a position close to the collection port array is formed longer than a projection portion 131 of the discharge port far from the collection port array. With this configuration, the flow resistances are formed in such a manner that the flow resistance as viewed from the pressure generation element to the discharge port is larger than that on the side on which the flow resistance of a flow path connected to the pressure chamber is smaller. In other words, as viewed from the direction in which to discharge the liquid from the discharge port 13, the flow resistance of the discharge port 13 is larger on the side of the first flow path than that on the side of the second flow path.

An advantageous effect of the first embodiment is described with use of a comparative example.

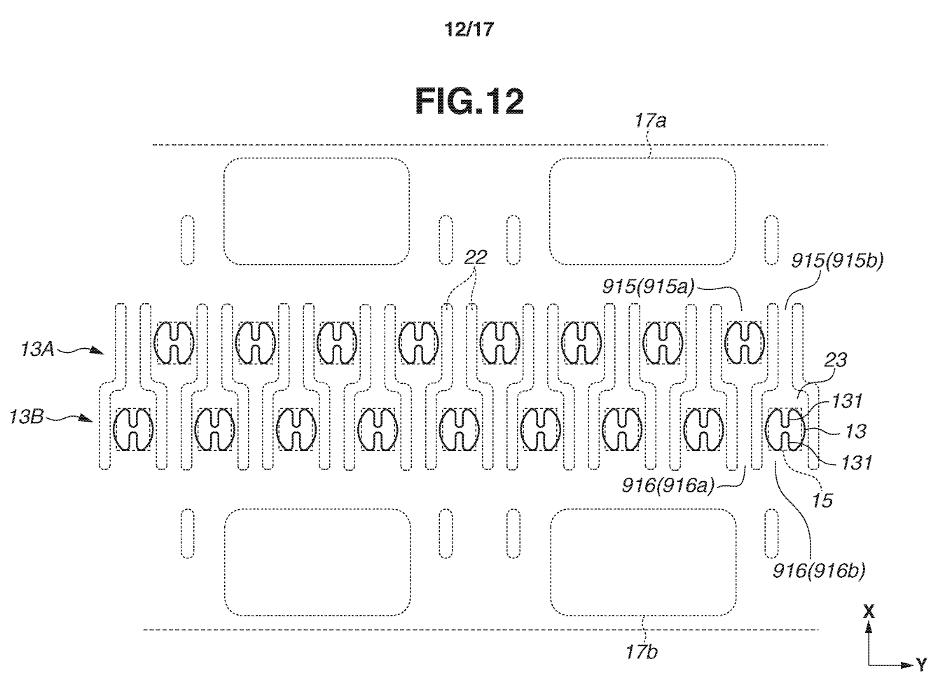

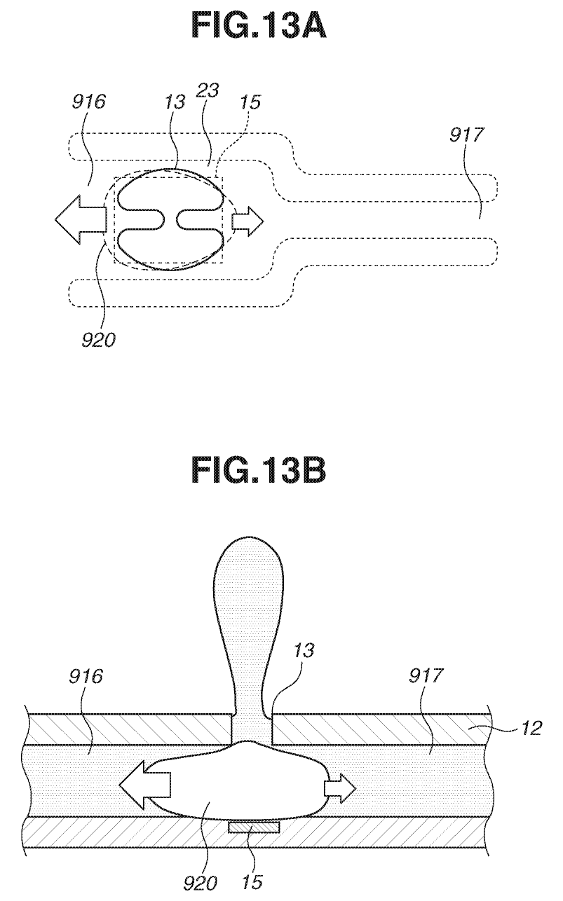

FIG. 12 illustrates the inside of a liquid discharge head in the comparative example, and is a plan view (see-through diagram) illustrating discharge ports 13, heating resistance elements 15, and flow paths. The comparative example differs from the first embodiment illustrated in FIGS. 11A and 11B in that the lengths of the projection portions 131 included in each discharge port 13 are the same length unlike the first embodiment. Moreover, FIGS. 13A and 13B are enlarged views of the vicinity of a pressure chamber representing the manner of bubble generation at the time of discharge in the comparative example, in which FIG. 13A is a planar schematic diagram of the vicinity of one pressure chamber and FIG. 13B is a sectional schematic diagram of the vicinity of the pressure chamber. When a bubble 920 is generated by the heating resistance element 15, since the respective flow resistances of the inflow path 915 and the outflow path 916 connected to one pressure chamber 23 differ from each other, the bubble 920 becomes larger on the side in which the flow resistance is smaller (the left side in FIG. 13B). Therefore, the liquid droplet to be discharged is drawn to the bubble 920 and flies while slightly inclining in the direction toward the position in which the bubble 920 is larger at the time of flying. On the other hand, in a pressure chamber 23 adjacent in the discharge port array direction, the magnitude relationship of flow resistances between the inflow path 915 and the outflow path 916 is opposite to the above-mentioned one. Therefore, liquid droplets fly in the respective opposite directions from the adjacent discharge ports. Therefore, the landing positions deviate in the respective opposite directions, thus leading to deterioration of the printing quality.

On the other hand, in the first embodiment illustrated in FIGS. 11A and 11B, the flow resistance in the discharge port 13 is larger on the side on which the flow resistance of the individual flow path is smaller and is smaller on the side on which the flow resistance of the individual flow path is larger. Specifically, with regard to two projection portions provided in one discharge port 13, the projection portion provided on the side on which the flow resistance of the individual flow path is smaller is formed longer, and the projection portion provided on the side on which the flow resistance of the individual flow path is larger is formed shorter. Due to the asymmetricity of flow resistances caused by the asymmetricity of projection portions 131 in the discharge port 13, the flying direction of a liquid droplet inclines toward the side on which the flow resistance in the discharge port is smaller. With this configuration, it is possible to cancel the inclination caused by the asymmetricity of flow resistances in the pressure chamber with the inclination of the flying direction of the discharge liquid droplet, so that the landing position deviation is reduced and the discharge performance and the image quality associated therewith are improved.

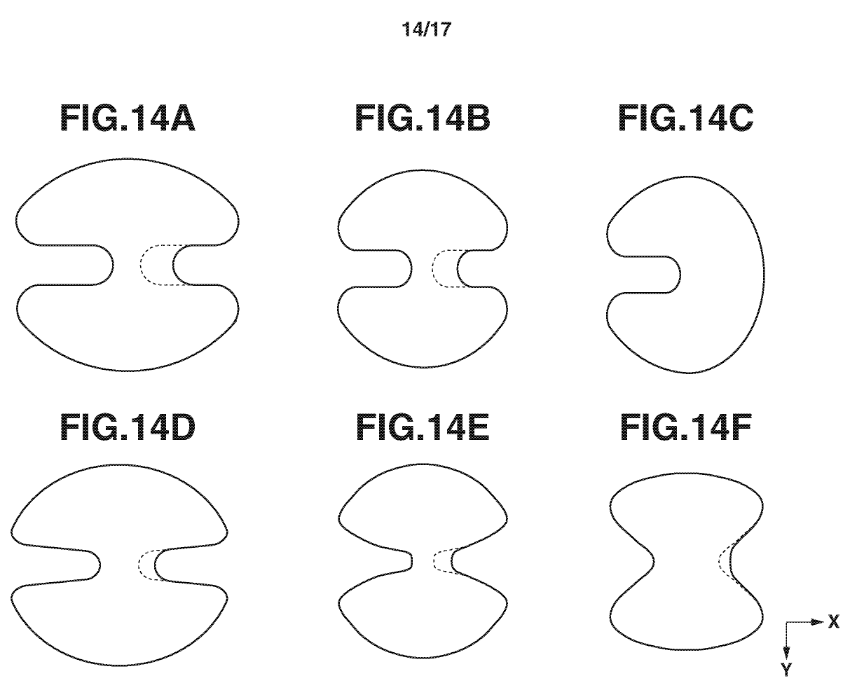

Furthermore, the shape of the discharge port 13 may be a shape which enables, in such a way as to obtain the above-mentioned advantageous effect, the flow resistance to become larger on the side on which the flow resistance in the flow path is smaller and to become smaller on the side on which the flow resistance in the flow path is larger, and is not limited to the shape illustrated in FIG. 11A. FIGS. 14A to 14F illustrate examples of discharge port shapes according to the first embodiment of the present disclosure. Furthermore, each dashed line indicates the shape of a discharge port in a case where the sizes of two projection portions 131 are equal to each other. FIG. 14A is an enlarged view of the discharge port 13 illustrated in FIG. 11A. The discharge port 13 illustrated in FIG. 14A has a flattened shape in which, to arrange discharge ports at high density in the array direction of discharge ports, the size of a discharge port in the array direction of discharge ports (Y-direction) is smaller than the length thereof in the direction perpendicular to the discharge port array (X-direction). In other words, in the first direction (X-direction), the inflow path (first flow path) 915 and the outflow path (second flow path) 916 are connected to the pressure chamber 23 across the pressure chamber 23, and the size of the discharge port 13 is smaller in the second direction (Y-direction) perpendicular to the first direction than that in the first direction. Here, the "size of the discharge port" can be considered based on the size of the diameter of a virtual shape obtained in a case where the discharge port does not include projection portions. Furthermore, as long as the discharge port fits into the inside of the pressure chamber 23, the discharge port can have a vertically long shape which is long in the Y-direction as illustrated in FIG. 14B. Moreover, in a case where the inclination of the liquid droplet flying direction caused by the shape of a pressure chamber or flow path is large and the flying direction of the discharge liquid droplet cannot be completely corrected by the length difference of projection portions, the discharge port can have a shape in which the discharge port includes only one projection portion as illustrated in FIG. 14C.

Moreover, the shape of a projection portion is also not limited to an approximately parallel linear shape such as that illustrated in FIG. 14A. In FIG. 14D, the projection portion 131 has an approximately trapezoidal shape in which the width thereof on the side of the center of the discharge port 13 (at the front edge side) is thinner than that at the base portion. Thickening the base of the projection portion enables preventing or reducing the projection portion from breaking when receiving external force by, for example, a recovery operation such as wiping. For the purpose of increasing the strength of the projection portion, the discharge port 13 can have a shape in which the projection portion 131 becomes thicker while being curved toward the base thereof as illustrated in FIG. 14E, or the discharge port 13 can have a shape in which the projection portion 131 is curved and the base thereof is formed thick as illustrated in FIG. 14F. Even in any discharge port shape, the projection portion 131 of the discharge port 13 is formed longer as it is closer to the side on which the flow resistance of the individual flow path is smaller. Accordingly, the flow resistance of the discharge port becomes larger as it is closer to the side on which the flow resistance of the flow path is smaller. With this configuration employed, it is possible to cancel the inclination of flying of the discharge liquid droplet caused by the asymmetricity of flow resistances in the pressure chamber and the individual flow path with the inclination of flying of the discharge liquid droplet caused by the asymmetricity of flow resistances of the discharge port, so that the landing position deviation can be prevented or reduced. As a result, it is possible to attain a high image quality.

### Second Embodiment

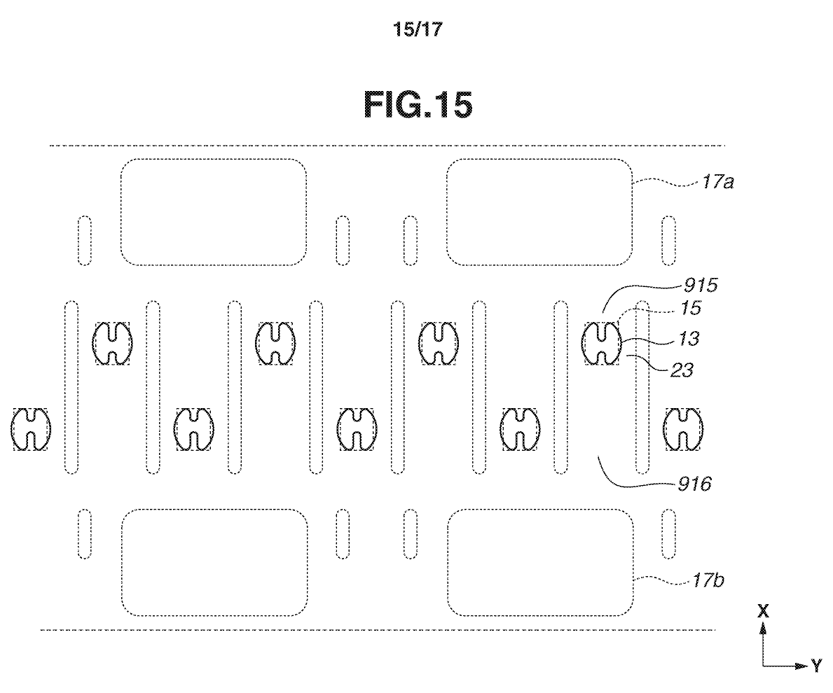

FIG. 15 illustrates the inside of a liquid discharge head in a second embodiment. In the second embodiment illustrated in FIG. 15, two flow paths (the inflow path 915 and the outflow path 916) connected to one pressure chamber 23 have the same width, but the length of one flow path is set larger than the length of the other flow path. In this case, since the flow resistance of the individual flow path on the side of a flow path the length of which is longer out of the inflow path 915 and the outflow path 916 becomes larger, the discharge port 13 is formed in a shape which makes the flow resistance smaller on the side of a flow path the length of which is longer out of the inflow path 915 and the outflow path 916. With this configuration employed, it is possible to cancel the inclination of flying caused by the asymmetricity of flow resistances in the pressure chamber with the inclination of flying direction of the discharge liquid droplet, so that the landing position deviation can be prevented or reduced.

### Third Embodiment

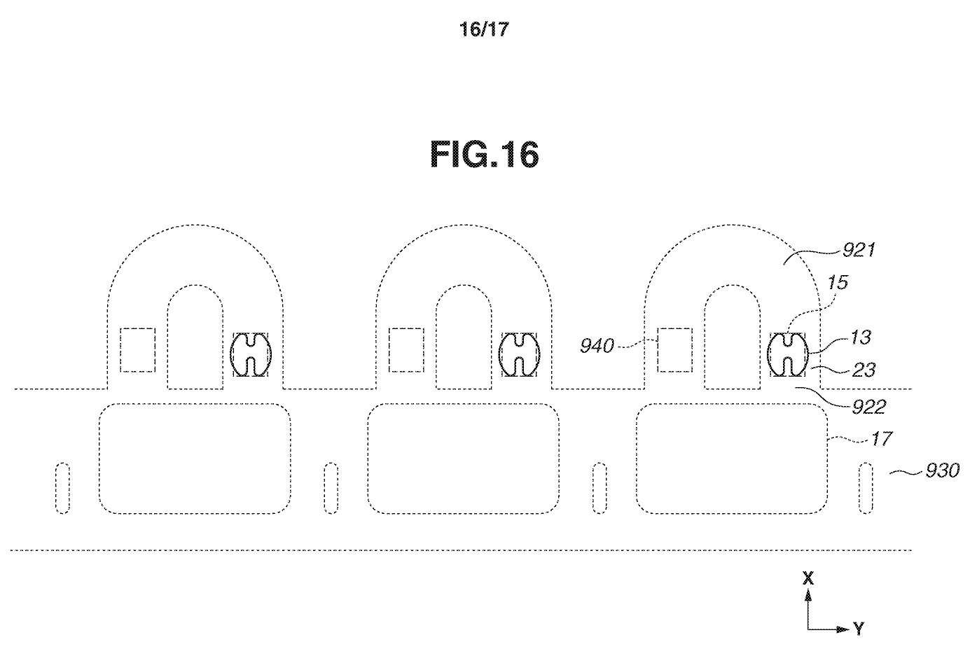

FIG. 16 illustrates the inside of a liquid discharge head in a third embodiment. In the third embodiment illustrated in FIG. 16, both two supply flow paths 921 and 922 connected to the pressure chamber 23 are connected to a common flow path 930 fluidically connected to a liquid supply port 17, and a U-shaped flow path is formed by the supply flow paths 921 and 922 and the pressure chamber 23. A pump 940 is arranged in the supply flow path 921, and driving the pump 940 enables generating the flow of a liquid flowing through the supply flow path 921, the pressure chamber 23, the supply flow path 922, and the common flow path 930 in this order. The supply flow path 922 is longer in the length of a flow path than the supply flow path 921 and is higher in flow resistance than the supply flow path 921. Therefore, the discharge port 13 is formed in a shape which makes the flow resistance smaller on the side of the supply flow path 922. With this configuration employed, it is possible to cancel the inclination of flying of the discharge liquid droplet caused by the asymmetricity of flow resistances in the individual flow path and the pressure chamber 23 with the inclination of flying direction of the discharge liquid droplet, so that the landing position deviation can be prevented or reduced. As a result, it is possible to attain a high image quality.

### Fourth Embodiment

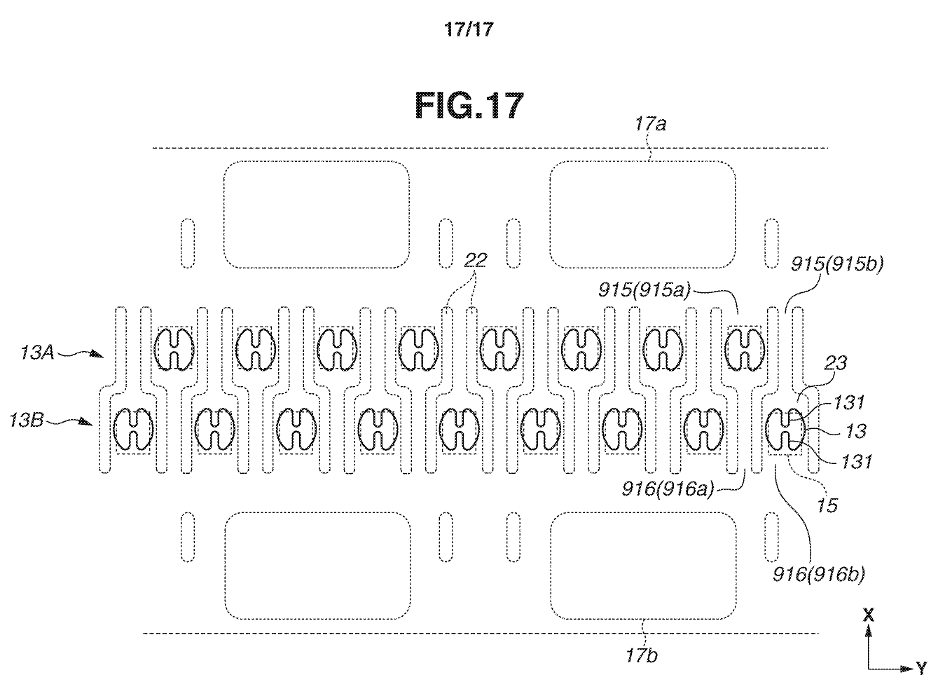

FIG. 17 illustrates the inside of a liquid discharge head in a fourth embodiment, and corresponds to FIG. 11A in the first embodiment. In the fourth embodiment illustrated in FIG. 17, the flow resistance in the discharge port 13 is adjusted with use of not the shape of the discharge port 13 but the positional relationship between the discharge port 13 and the heating resistance element 15. Furthermore, the respective lengths of two projection portions 131 included in the discharge port 13 in the fourth embodiment are the same. As illustrated in FIG. 17, as viewed from the direction in which to discharge a liquid, the center of the discharge port 13 deviates from the center of the heating resistance element 15 toward a side on which the flow resistance of the individual flow path is larger. With this configuration, the flow resistance as viewed from the heating resistance element 15 to the discharge port 13 becomes larger than on the side on which the flow resistance is smaller out of the supply flow paths 915 and 916. Accordingly, the flying direction of the discharge liquid droplet becomes inclined toward the side on which the flow resistance is smaller, and it is possible to cancel the inclination of flying of the discharge liquid droplet caused by the asymmetricity of flow resistances in the individual flow path and the pressure chamber 23 with the deviation of the position of the discharge port 13 relative to the heating resistance element 15, so that the landing position deviation can be prevented or reduced. As a result, it is possible to attain a high image quality. Furthermore, as the "center", for example, in the case of the discharge port 13, the center of mass in a surface on which the discharge ports 13 of the flow path forming member 12 are formed can be used or, in the case of the heating resistance element 15, the center of mass in a surface on which the heating resistance elements 15 of the substrate 11 are formed can be used.

### Other Embodiments

The above-described embodiments can be modified in various manners. Two or more aspects which are optionally selected from the respective embodiments can be combined to the extent that they do not contradict each other.

Moreover, the present disclosure is not limited to a circulation configuration in which a liquid which has not been discharged from the collection ports 17b flows out. The present disclosure can be applied to a configuration in which a liquid is supplied to the pressure chamber 23 from both the supply ports 17a and the collection ports 17b illustrated in FIG. 11A or a configuration in which only the supply ports 17a are included.

According to the present disclosure, it is possible to attain a liquid discharge head capable of arranging discharge ports at high density as well as preventing or reducing landing position deviation.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of priority from Japanese Patent Application No. 2025-050809 filed March 25, 2025, which is hereby incorporated by reference herein in its entirety.

What is claimed is:

1. A liquid discharge head comprising:
a discharge port configured to discharge a liquid;
an individual flow path including a pressure chamber which communicates with the discharge port while facing the discharge port in a direction in which to discharge the liquid, a first flow path connected to the pressure chamber, and a second flow path connected to the pressure chamber on a side opposite to the first flow path; and
a common flow path connected to a plurality of individual flow paths each corresponding to the individual flow path,
wherein a flow resistance of the first flow path is smaller than a flow resistance of the second flow path, and
wherein, as viewed from the direction in which to discharge the liquid, a flow resistance of the discharge port is larger on a side of the first flow path than on a side of the second flow path.

2. The liquid discharge head according to claim 1, wherein, as viewed from the direction in which to discharge the liquid, the discharge port includes at least two projections which project toward a center of the discharge port, and a length of one of the projections provided on a side closer to the first flow path than the center is larger than a length of another of the projections provided on a side closer to the second flow path than the center.

3. The liquid discharge head according to claim 1, wherein, as viewed from the direction in which to discharge the liquid, the discharge port includes at least two projections which project toward a center of the discharge port, and a width of one of the projections provided on a side closer to the first flow path than the center is larger than a width of another of the projections provided on a side closer to the second flow path than the center.

4. The liquid discharge head according to claim 1, wherein, as viewed from the direction in which to discharge the liquid, the discharge port includes only one projection which is provided on a side closer to the side of the first flow path than a center of the discharge port and projects toward the center.

5. The liquid discharge head according to claim 1, further comprising:
a discharge port forming member including the discharge port; and
a substrate configured to form the individual flow path and the common flow path between the substrate and the discharge port forming member.

6. The liquid discharge head according to claim 1, wherein a width of the first flow path is smaller than a width of the second flow path.

7. The liquid discharge head according to claim 1, wherein a length of the first flow path is larger than a length of the second flow path.

8. The liquid discharge head according to claim 1,
wherein both the first flow path and the second flow path are connected to the common flow path in common, and
wherein, as viewed from the direction in which to discharge the liquid, the individual flow path has a bent shape.

9. The liquid discharge head according to claim 1,
wherein, as viewed from the direction in which to discharge the liquid, in a first direction, the first flow path and the second flow path are connected to the pressure chamber across the pressure chamber, and
wherein a size of the discharge port is smaller in a second direction perpendicular to the first direction than that in the second direction.

10. The liquid discharge head according to claim 1, further comprising a heating resistance element configured to generate energy for discharging the liquid from the discharge port.

11. The liquid discharge head according to claim 10, wherein, as viewed from the direction in which to discharge the liquid, a center of the discharge port and a center of the heating resistance element deviate from each other.

12. The liquid discharge head according to claim 1, wherein the liquid present in the pressure chamber is circulated between an inside of the pressure chamber and an outside of the pressure chamber.

13. The liquid discharge head according to claim 1,
wherein, as viewed from the direction in which to discharge the liquid, in a first direction, the first flow path and the second flow path are connected to the pressure chamber across the pressure chamber,
wherein the common flow path includes a first common flow path connected to the first flow path and a second common flow path connected to the second flow path,
wherein a plurality of discharge ports each corresponding to the discharge port is arranged side by side in a second direction intersecting with the first direction, and
wherein the liquid discharge head further comprises two discharge port arrays in which the discharge ports adjacent in the second direction are arranged in such way as to deviate from each other in the first direction.

14. The liquid discharge head according to claim 13, wherein a discharge port density obtained with a combination of the two discharge port arrays in the second direction is 800 dots per inch (dpi) or more.

15. The liquid discharge head according to claim 13, wherein a discharge port density of each of the two discharge port arrays in the second direction is 600 dots per inch (dpi) or more.

16. A liquid discharge head comprising:
a discharge port configured to discharge a liquid;
an individual flow path including a pressure chamber which communicates with the discharge port while facing the discharge port in a direction in which to discharge the liquid, a first flow path connected to the pressure chamber, and a second flow path connected to the pressure chamber on a side opposite to the first flow path; and
a common flow path connected to a plurality of individual flow paths each corresponding to the individual flow path,
wherein a flow resistance of the first flow path is smaller than a flow resistance of the second flow path, and
wherein, as viewed from the direction in which to discharge the liquid, the discharge port includes at least two protrusions which protrude toward a center of the discharge port and a length of one of the projections provided on a side closer to the first flow path than the center is larger than a length of another of the projections provided on a side closer to the second flow path than the center.

17. The liquid discharge head according to claim 16, further comprising:
a discharge port forming member including the discharge port; and
a substrate configured to form the individual flow path and the common flow path between the substrate and the discharge port forming member.

18. The liquid discharge head according to claim 17,
wherein the common flow path includes a first common flow path connected to a plurality of first flow paths each corresponding to the first flow path and a second common flow path connected to a plurality of second flow paths each corresponding to the second flow path, and
wherein the substrate includes a first supply port connected to the first common flow path and being open on a side of the discharge port forming member of the substrate and a second supply port connected to the second common flow path and being open on the side of the discharge port forming member of the substrate.

19. The liquid discharge head according to claim 18, wherein the substrate includes a plurality of first supply ports each corresponding to the first supply port and a plurality of second supply ports each corresponding to the second supply port.
